(19) United States
(12) Patent Application Publication
(10) Pub. No.: US 2015/0285943 A1
(43) Pub. Date: Oct. 8, 2015

(54) Alpha Processing to Improve Accuracy and Precision of Elemental Concentrations from Gamma-Ray Spectroscopy

(71) Applicant: SCHLUMBERGER TECHNOLOGY CORPORATION, Sugar Land, TX (US)

(72) Inventors: Christian Stoller, Princeton Junction, NJ (US); James A. Grau, Marshfield, MA (US); Markus Berheide, Medford, MA (US)

(21) Appl. No.: 14/434,735

(22) PCT Filed: Oct. 11, 2013
(86) PCT No.: PCT/US13/64527

§ 371 Date: Apr. 9, 2015

Related U.S. Application Data
(60) Provisional application No. 61/713,067, filed on Oct. 12, 2012.

(51) Int. Cl. G01V 5/08; E21B 49/00

(52) U.S. Cl. CPC G01V 5/08; E21B 49/00

(57) ABSTRACT

A method for improving precision of measurement of material composition of formations determined by gamma ray spectral an analysis includes determining an accurate value of an amount of a selected by analyzing a spectrum of gamma rays detected from the formations using a technique that directly relates the gamma ray spectrum to the amount of the material. A precise value of the amount of the material is determined by analyzing the spectrum of detected gamma rays that indirectly relates the gamma ray spectrum to the amount of the material. A function relating the accurate value to the precise value over a selected axial interval along the wellbore is determined. The function is applied to the accurate value at at least one selected axial position along the wellbore to determine an accurate and precise value of the amount of the material.

### BACKGROUND

This disclosure relates generally to the field of analysis of composition of subsurface formations from gamma ray spectroscopy. More specifically, the disclosure relates to techniques for improving both accuracy and precision of such analysis from gamma ray spectroscopic measurements of subsurface formations.

Improvements gamma-ray spectroscopy made using instruments deployed in wellbores drilled through subsurface formations have led to renewed interest in direct determination of the aluminum content of subsurface formations. Aluminum is difficult to determine because it has a small cross section for neutron capture and inelastic interactions. In addition, the capture gamma-ray spectrum of aluminum has a strong covariance with the capture gamma ray spectrum of iron, in particular, if the spectral resolution of the gamma ray detector is inadequate. Aluminum is an excellent quantitative indicator of clay and an accurate determination of the aluminum concentration can be used to quantify the presence of minerals such as shale (clay) in earth formations.

An approach was developed in the 1990s to determine clay content of formations indirectly by inferring it from the presence of other elements such as Fe, Si and Ca (called the WALK algorithm), i.e., without a measurement related to the quantity of aluminum and/or potassium in the formations.

Aluminum presence in formations may be determined in multiple ways through analysis of neutron-induced gamma rays. In the 1980s a method was developed to measure gamma-rays resulting from activation of 27Al by thermal neutrons: 27Al(n,γ) 28Al. The activated Al isotope decays through beta emission and subsequent gamma-decay (with an energy of 1780 keV) of the excited state of 28Al. The foregoing technique is described in Hertzog et al, Geochemical Logging with Spectrometry Tools, SPE Journal of Formation Evaluation, 1989, paper 16792) and in U.S. Pat. No. 4,810,876 issued to Wraight et al. Another technique is measurement of the gamma-rays following the capture of a thermal neutron by aluminum. The primary high energy capture gamma rays have energies of 7724 and 7695 keV, which is very close to the energy of primary capture gamma rays of 56Fe at 7646 and 7632 keV. In addition, the thermal neutron capture cross section of Al is comparatively small. Another possibility is to detect the gamma rays caused by inelastic scattering of high energy neutrons by aluminum as described in, The Mars Odyssey Gamma-Ray Spectrometer Instrument Suite, by Boynton et al., Space Science Reviews 110: 37-83, 2004, Kluwer Academic Publishers. Such technique is similarly described in U.S. Pat. No. 7,402,797 issued to Pemper et al.

There continues to be a need for improved techniques for formation composition analysis using gamma ray spectroscopy.

### SUMMARY

One aspect is a method for improving precision of measurement of material composition of formations determined by gamma ray spectral analysis. It includes determining an accurate value of an amount of a material selected by analyzing a spectrum of gamma rays detected from the formations using a technique that directly relates the gamma ray spectrum to the amount of the material. A precise value of the amount of the material is determined by analyzing the spectrum of detected gamma rays that indirectly relates the gamma ray spectrum to the amount of the material. A function relating the accurate value to the precise value over a selected axial interval along the wellbore is determined. The function is applied to the accurate value at at least one selected axial position along the wellbore to determine an accurate and precise value of the amount of the material.

Other aspects and advantages of the invention will be apparent from the description and claims which follow.

### BRIEF DESCRIPTION OF THE DRAWINGS

FIG. 1 shows an example well logging instrument system that may be used by drilling a wellbore through subsurface formations.

FIG. 2 shows an example well logging instrument system that may be used in an already drilled wellbore and conveyed by electrical cable.

FIG. 3 shows an example computer system for performing example implementations according to the present disclosure.

FIG. 4 shows a graph of dry weight aluminum determined from Al spectral yield (from Al) and indirectly from other elements (emulated).

FIG. 5 shows a graph of difference between the accurate and precise measurement as a function of depth and filtered difference using a 15-level and a 21-level average.

FIG. 6 shows a graph of difference between “precise” and “accurate” and alpha-factors derived from the difference, alpha-15 corresponds to a 15-level average, alpha-21 to a 21-level average and alpha-poly to a curve approximation by a 3^{rd} order polynomial over 15-levels.

FIG. 7 shows a graph of a third order polynomial fit over 15 points (indicated by diamonds) and the average over 15 levels (indicated by triangles) compared to the measured data.

FIG. 8 shows a graph of accurate and precise measurements together with the alpha-offset (Alpha_{—}0) and the alpha processed result (Precise+Alpha_{—}0).

FIG. 9 shows a graph of alpha values for 21-level difference (Alpha-21), polynomial fit of difference (Alpha-Poly) and constant and linear term of fit. The strong anti-correlation between alpha-0 and alpha-1 and the strong variability indicate a poor and not very stable correlation.

FIG. 10 shows a graph of results of different approaches to alpha-processing: Sliding average difference over 21 levels (DWAL_Alpha_{—}21) or linear fit according to equation (10) (linear fit)

FIG. 11 shows a graph of values of alpha factor for 0^{th} and 1^{st} order processing from processing volume of oil from a carbon-oxygen measurement as a function of depth. Alpha_{—}0 represents the approach using just the average difference. Alpha_{—}0_lin is the constant term in equation (10) and Alpha_{—}1_lin the first order (linear) term.

FIG. 12 shows a graph of precise and accurate measurements and alpha-processed results from the volume-of-oil determination using an offset (Precise+Alpha_{—}0) and using the linear approach of equation (10) (linear fit).

FIG. 13 shows a graph of dry weigh aluminium determined from spectroscopic measurements compared to that obtained by emulation.

### DETAILED DESCRIPTION

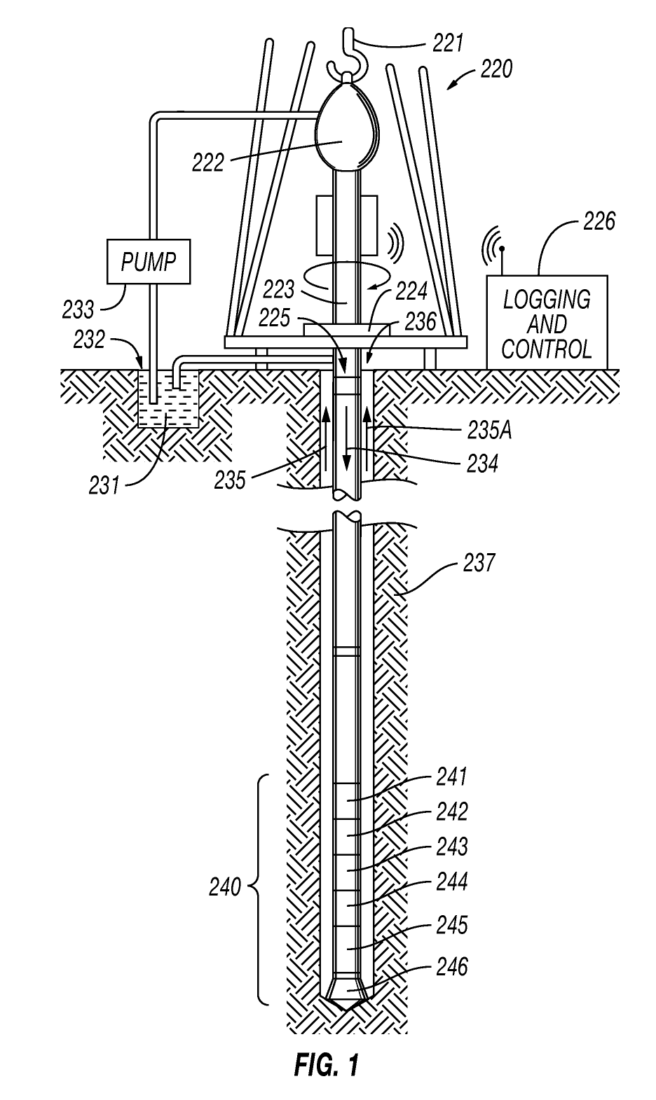

The example methods disclosed herein may be based on gamma ray spectroscopy measurements made from instruments conveyed into wellbores drilled through subsurface formations. Methods or means of conveyance of the instruments may include any methods or means of conveyance known to those of ordinary skill in the art. FIG. 1, for example, illustrates a wellsite system in which data to be used according to examples of the present disclosure may be used by conveyance of the instruments as part of a “dril string.” The wellsite can be onshore or offshore. In this example system, a wellbore may be formed in subsurface formations by rotary drilling in a manner that is well known.

The drill string 225 is suspended within a borehole 236 and may have a bottom hole assembly (BHA) 240 which includes a drill bit 246 at its lower end. A surface drilling system 220 includes platform and derrick assembly positioned over the borehole 236, the assembly including a rotary table 224, kelly (not shown), hook 221, and rotary swivel 222. The drill string 225 is rotated by the rotary table 224 (energized by means not shown), which engages the kelly (not shown) at the upper end of the drill string 225. The drill string 225 is suspended from the hook 221, attached to a traveling block (also not shown), through the kelly (not shown) and the rotary swivel 222 which permits rotation of the drill string 225 relative to the hook 221. As is well known, a top drive system could be used instead of the system shown in FIG. 1.

In the illustrated example, the surface system further includes drilling fluid or mud 232 stored in a pit 231 formed at the well site. A pump 233 delivers the drilling fluid to the interior of the drill string 225 via a port (not shown) in the swivel 222, causing the drilling fluid 232 to flow downwardly through the drill string 225 as indicated by the directional arrow 234. The drilling fluid 232 exits the drill string 225 via ports (not shown) in the drill bit 246, and then circulates upwardly through an annular space 235 between the outside of the drill string 225 and the wall of the wellbore 236, as indicated by the directional arrows 235 and 235A. In this well known manner, the drilling fluid 232 cools and lubricates the drill bit 246, and carries formation cuttings up to the surface as it is returned to the pit 231 for recirculation.

The BHA 240 of the illustrated embodiment may include various measuring instruments, including a measuring-while-drilling (MWD) tool 241, and various logging-while-drilling (LWD) tools 242, 243, 244, a rotary steerable directional drilling system 245 and mud 232 operated motor, and the drill bit 250. The LWD tools 242, 243, 244 may be housed in a special type of drill collar, as is known in the art, and can contain one or a plurality of known types of logging tools. The LWD tools 242, 243, 244 may include capabilities for measuring, processing, and storing information, as well as for communicating with the surface equipment. In the present example, one of the LWD tools 242 may include at least one scintillation type radiation detector 242B with a multichannel analyzer adapted to fit in the special drill collar for performing natural gamma ray emission spectroscopic analysis. An example scintillation type radiation detector with a multichannel analyzer is described in U.S. Pat. No. 7,073,378 issued to Smits et al. and incorporated herein by reference. Such detectors may include a scintillation material (which may be in crystalline form) optically coupled to a photomultiplier tube. The scintillation material may be materials, for example and without limitation, such as thallium-doped sodium iodide and gadolinium oxyorthosilicate.

The other LWD tools 243, 244 may also each include at least one scintillation type radiation detector, 243B, 244B, respectively, as well as respective radiation sources 243A, 244A to impart radiation such as neutrons and gamma rays to the formations adjacent the wellbore 226. The sources 243A, 244A may be radioisotopic or electrically powered sources. The respective radiation detectors 243B, 244B may characterize the spectrum of gamma rays returning from the formations by energy level as a result of interaction of the source emitted radiation in order to evaluate mineral composition and fluid content of the formations.

The MWD tool 241 may also be housed in a special type of drill collar, as is known in the art, and can contain one or more devices for measuring characteristics of the drill string and drill bit. The MWD tool 241 may further include an apparatus (not shown separately) for generating electrical power to the downhole system. This may typically include a mud turbine generator powered by the flow of the drilling fluid, it being understood that other power and/or battery systems may be employed. In the present embodiment, the MWD tool 241 may include one or more of the following types of measuring devices: a weight-on-bit measuring device, a torque measuring device, a vibration measuring device, a shock measuring device, a stick slip measuring device, a direction measuring device, and an inclination measuring device. The power generating apparatus (not shown) may also include a drilling fluid flow modulator for communicating measurement and/or tool condition signals to the surface for detection and interpretation by a logging and control unit 226.

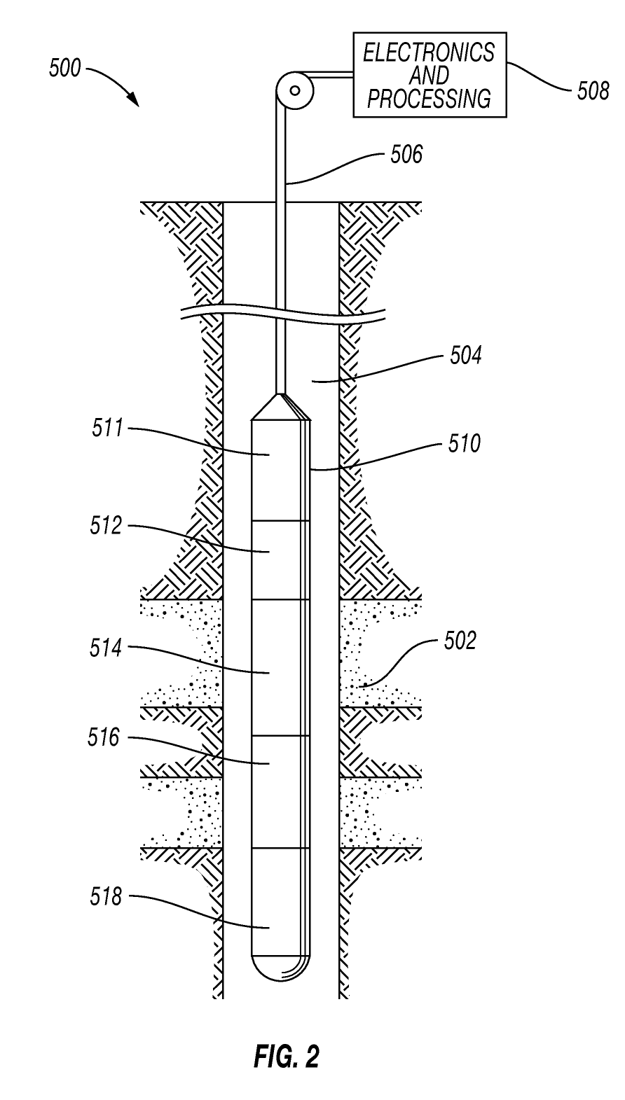

Referring to FIG. 2, an example wireline tool 510 is shown that may be another environment in which aspects of the present disclosure may be implemented. The example wireline tool 510 is suspended in a wellbore 504 from the lower end of an armored multiconductor cable 506 that is spooled on a winch (not shown) at the Earth's surface. At the surface, the cable 506 is communicatively coupled to an electronics and processing system 508. The example wireline tool 510 includes an elongated body that may include various instruments 511-514 each having at least one scintillation type radiation detector with a multichannel analyzer (and some having radiation sources) corresponding to the LWD instruments shown in FIG. 1. Additional components may also be included in the wireline tool 510, e.g., acoustic and resistivity measuring instruments 516, 518, respectively. Each such above described instrument may measure a particular formation, e.g., 502 as the instrument 510 is withdrawn from the wellbore 504 using the cable 506. It will be appreciated by those skilled in the art that the measurements made by the various instruments in FIG. 2 may be recorded (in surface system 508) at predetermined axial movement (depth) intervals, such as 0.025 inches or 0.5 inches. The system shown in FIG. 2 may make a record of instrument measurements with respect to time, record such measurements in a memory or data storage device (not shown) therein and generate a measurement to depth record by correlating the recorded measurement time records to a depth/time record made by the logging and control system (226 in FIG. 1). The correlated record maybe output in the same or different axial movement (depth) intervals as those may by the system shown in FIG. 2.

Though FIGS. 1 and 2 illustrate example while-drilling and wireline systems of conveyance, respectively, other systems of conveyance can be used in other examples. Examples of other systems of conveyance that can be used with certain aspects described in the present disclosure include coiled tubing, drillpipe, and slickline systems.

Certain aspects or components of the disclosure can comprise a computer program that embodies the functions described herein and illustrated in the flow charts. The computer (not shown) may be disposed at the surface, e.g., in logging and control unit 226 in FIG. 1 or electronics and processing system 508 in FIG. 2. However, it should be apparent that there could be many different ways of implementing the invention in computer or algorithmic programming, and the disclosure should not be construed as limited to any one set of program instructions. Further, a skilled programmer would be able to write such a program to implement an embodiment of the disclosed example methods based on the associated description herein. Therefore, disclosure of a particular set of program code instructions is not considered necessary for an adequate understanding of how to make and use the example methods disclosed herein.

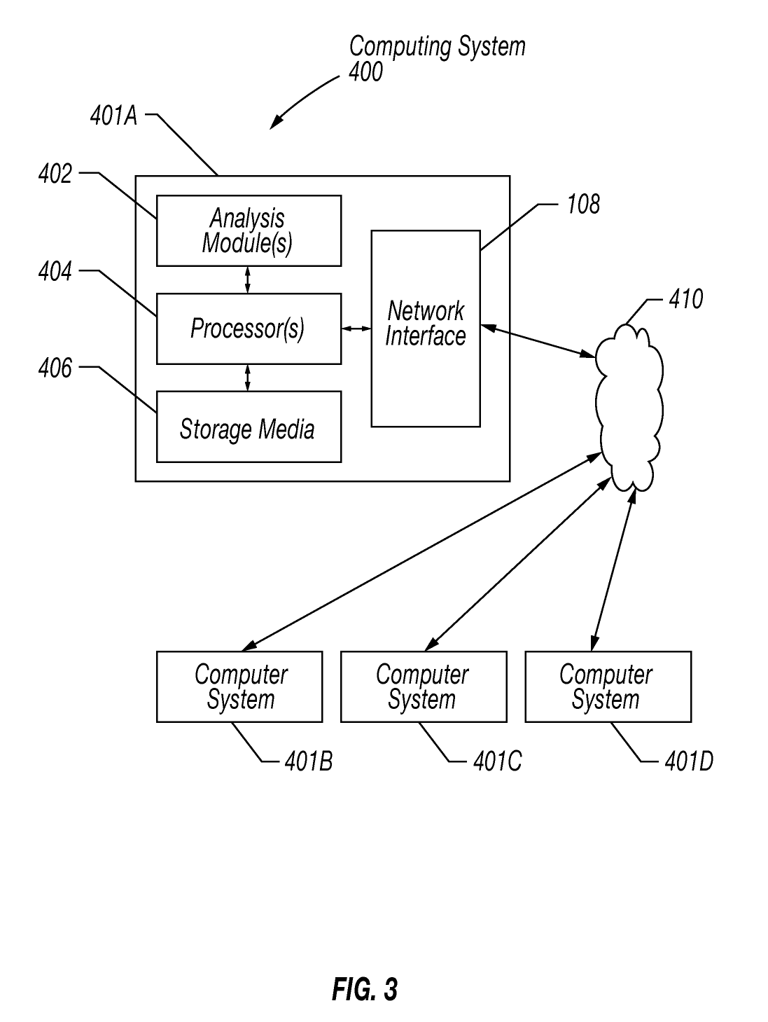

FIG. 3 depicts an example computing system 400 in accordance with some embodiments. The computing system 400 can be an individual computer system 401A or an arrangement of distributed computer systems. The computer system 401A may include one or more analysis modules 402 that are configured to perform various tasks according to some embodiments. To perform these various tasks, analysis module 402 may execute independently, or in coordination with, one or more processors 404, which may be connected to one or more storage media 406. The processor(s) 404 may also be connected to a network interface 408 to allow the computer system 401A to communicate over a data network 410 with one or more additional computer systems and/or computing systems, such as 401B, 401C, and/or 401D. Note that computer systems 401B, 401C and/or 401D may or may not share the same architecture as computer system 401A, and may be located in different physical locations, e.g. computer systems 401A and 401B may be at a wellsite (FIGS. 1 and 2), while in communication with one or more computer systems such as 401C and/or 401D that are located in one or more data centers, and/or located in varying countries on different continents.

A processor can include a microprocessor, microcontroller, processor module or subsystem, programmable integrated circuit, programmable gate array, or another control or computing device.

The storage media 406 may be implemented as one or more computer-readable or machine-readable storage media. Note that while in the example embodiment of FIG. 3 storage medium 406 is depicted as within computer system 401A, in some embodiments, storage media 406 may be distributed within and/or across multiple internal and/or external enclosures of computing system 401A and/or additional computing systems. Storage media 406 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 400 is only one example of a computing system, and that computing system 400 may have more or fewer components than shown, may combine additional components not depicted in the example embodiment of FIG. 3, and/or computing system 400 may have a different configuration or arrangement of the components depicted in FIG. 3. The various components shown in FIG. 3 may be implemented in hardware, software, or a combination of hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

The present description includes example methods for well log data processing, in which an “accurate” measurement with a relatively large statistical error is combined with a statistically precise, yet more inaccurate measurement of the same physical parameter to obtain a combined measurement which is more precise and accurate than the individual measurements themselves. The following definitions may be used herein:

Precise: A measurement or derived quantity with a small statistical error (thus having good repeatability).

Accurate: A measurement or derived quantity, which is close to the true value, but whose statistical error may or may not be acceptable.

While the basic idea of the foregoing combined measurement data processing is described in U.S. Pat. No. 4,786,796 referred to in the Background section herein, the method disclosed therein concerned only a technique by which to improve the vertical (axial) resolution of neutron porosity measurement or of gamma-gamma density measurements by combining a statistically precise, yet inaccurate high resolution measurements made from a “near” detector (one spaced axially closer to a neutron or gamma ray source) with more accurate, lower vertical resolution measurements made by a “far” detector (one spaced further from the neutron or gamma ray source). As explained above, the foregoing method relies on a combination of a statistically precise but potentially inaccurate measurements combined with accurate but statistically more imprecise measurements having a different vertical resolution.

In the present disclosure, a generalized approach is presented, which is not necessarily related to obtaining a high resolution measurement requiring signals from more than one sensor, but rather to performing a measurement with better statistical precision combined with one that has higher accuracy to obtain a more accurate, precise overall result. This approach is referred to herein as alpha processing. The underlying assumption in the present example method is that, at least over a limited axial interval in a wellbore, the accurate measurement can be described as a function of the precise measurement. The function can be derived over a user selected axial length (depth) interval, e.g., over a longer selected interval to improve the statistical precision. The length of the depth interval may depend on whether rapid changes in correlation between the accurate and precise measurements are expected. Lengthening the interval may improve the precision with which the correlation can be determined and therefore the precision improvement of the final calculated results. Precautions may be taken to reduce the length of the interval over which the function is determined or to stop the alpha processing altogether if a sharp change in the correlation is found, which would undermine the foregoing assumption. The process explained below may be applied to each of the individual radiation detector measurements made by the instruments shown in FIGS. 1 and 2, for example. The processing may be performed on computer systems as explained with reference to FIG. 3.

In its simplest form the processing (called “alpha” processing) proposed in the present example may be implemented as follows. First, an average difference may be determined between the accurate and the precise measurement over a long depth interval (e.g. 21, depth increment levels of 6 inches each or 10.5 ft). Then, add the average difference to the precise measurement to obtain the alpha processed result.

The foregoing method may be used to improve precision of gamma ray spectroscopy measurements while maintaining their accuracy. An example is given below for combining an accurate determination of aluminum dry weight in a formation from a direct measurement of the aluminum spectral yield from, e.g., thermal neutron capture gamma rays, with the more precise but less accurate determination of aluminum dry weight in the formation obtained from a combination of thermal neutron capture gamma ray spectroscopy of measurements of Ca, Si and Fe. In this example case, the processing can be implemented as follows.

First, determine the aluminum dry weight fraction of the formation from the aluminum yield(s) obtained from neutron activation, neutron capture gamma ray or neutron inelastic collision gamma ray spectroscopy, or a combination thereof (noting that a combination of the foregoing three dry weight fractions could follow the same procedure).

W_{Al}(direct)=s_{Al}·y_{Al} (1)

Where Wₐₗ is the dry weight fraction of Al in the formation, s_{Al} is a sensitivity coefficient for the conversion of the aluminum yield to an aluminum dry weight fraction and y_{Al} is a properly normalized aluminum spectral yield.

Second, determine the aluminum dry weight using an indirect method such as an algorithm described in U.S. Pat. No. 5,786,595 issued to Herron et al. and incorporated herein by reference for all purposes. As an example, one can use the approach given in equation (3) of the Herron et al. '595 patent:

W_{Al}(indirect)=a·(100−W_{SiO}_{₂}−W_{CaCO}_{₃}−W_{MgCO}_{₃}−b·W_{Fe}) (2)

where Wxx represents the dry weights of quartz (SiO2), calcite (CaCO3), dolomite (CaCO3 and MgCO3) and iron (Fe) in the formation. a is constant that may be determined from measurements and simulations.

Over a certain length of well log (i.e., a measured axial interval of the wellbore), one may determine a function ƒ describing the direct measurement as a function of the indirect measurement for each instrument data output depth (axial position) level. As a non-limiting example, the function can be determined over 21 levels including 10 levels preceding (represented by LL) and 10 levels following the axial position of interest (represented by UU) and the axial position itself.

W̅_{Al}(direct)|_{LL}^{UU}=ƒᵢ( W̅_{Al}(indirect)|_{LL}^{UU}) (3)

One may then use the function derived from a long depth interval on a level-by-level basis to determine an accurate and precise value (alpha-processed) at each data output level for the aluminum weight fraction of the formation.

W_{Al}(alpha)=ƒᵢ(W_{Al}(indirect)) (4)

A simple approach is to use the averages shown in equation (5):

$$\frac{1}{UU - LL + 1} {\sum }_{j = LL}^{UU} {W}_{Al , j} ( direct ) = \frac{1}{UU - LL + 1} {\sum }_{j = LL}^{UU} {W}_{Al , j} ( indirect ) + {C}_{i} \qquad ( 5 )$$

where UU and LL are the upper and lower bounds of the interval over which the average is taken, j is the index of the samples in the interval, i denotes the index, typically, but not necessarily, in the center of the interval, around which the average is determined. The only necessary condition for the foregoing processing is that i is within the range defined between LL and UU.

The result given in equation (6) may be obtained by adding the constant Ci to obtain the precise result.

W_{Al,i}(alpha)=W_{Al,i}(indirect)+Cᵢ (6)

In this case, the average accurate (direct) measurement has an offset Ci with respect to the precise (indirect) measurement.

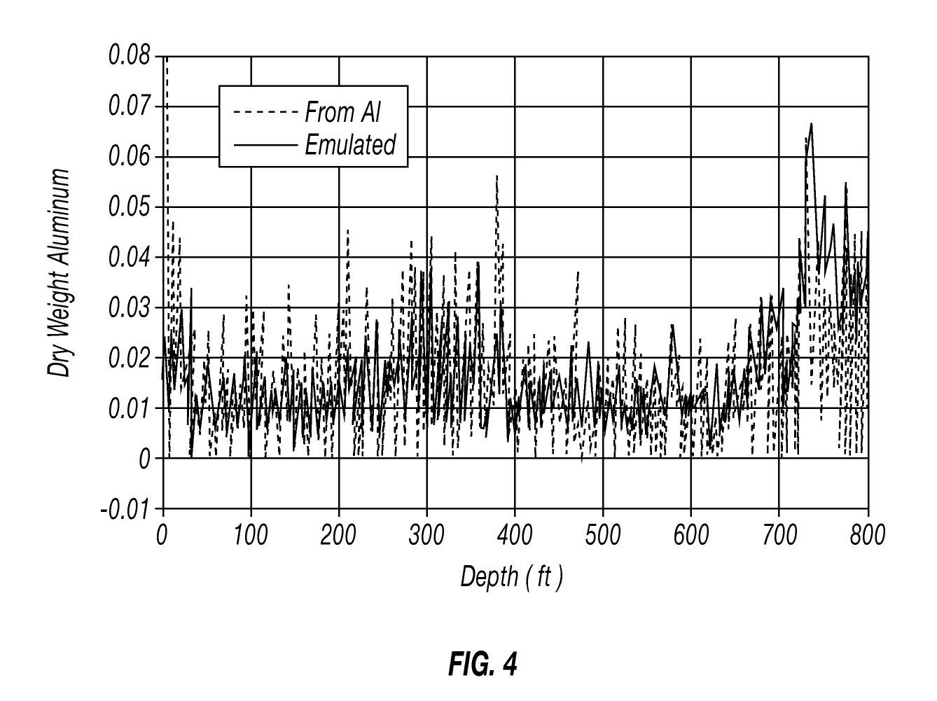

FIG. 4 shows a well log section with dry weight aluminum computed from the neutron capture gamma ray aluminum yield at curve 50 and dry weight aluminum computed indirectly (emulated) from other elements at curve 52. The statistical uncertainty of the emulated aluminum (the precise measurement) is about half of the uncertainty of the direct aluminum measurement. For most of the log section, the two curves correspond well.

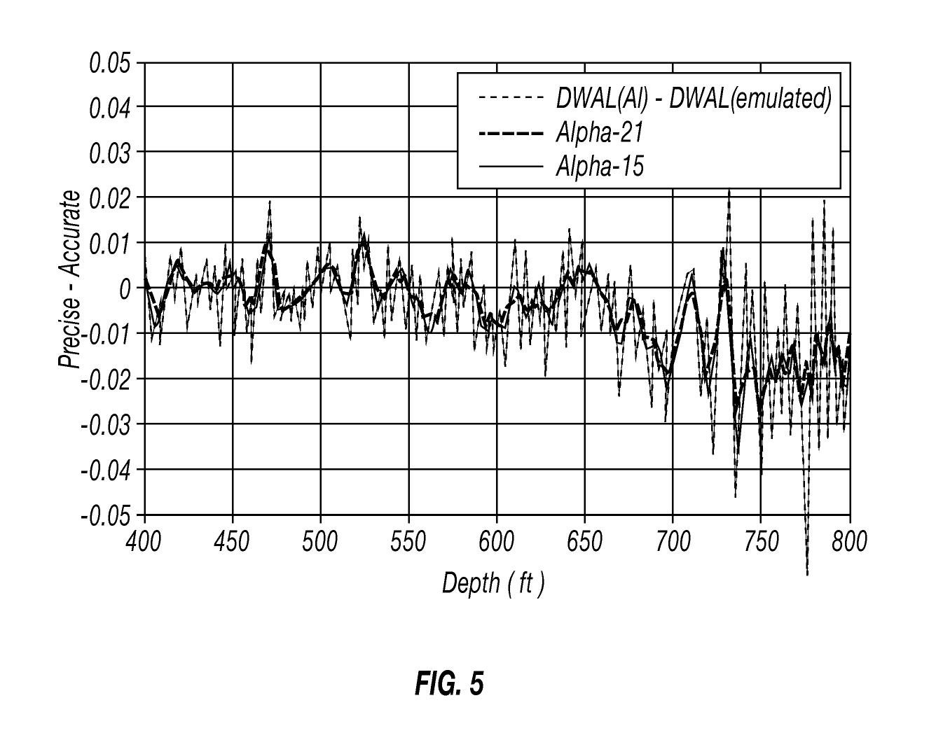

FIG. 5 shows a graph of difference between the accurate and precise measurement as a function of depth and filtered difference using a 15-level and a 21-level average.

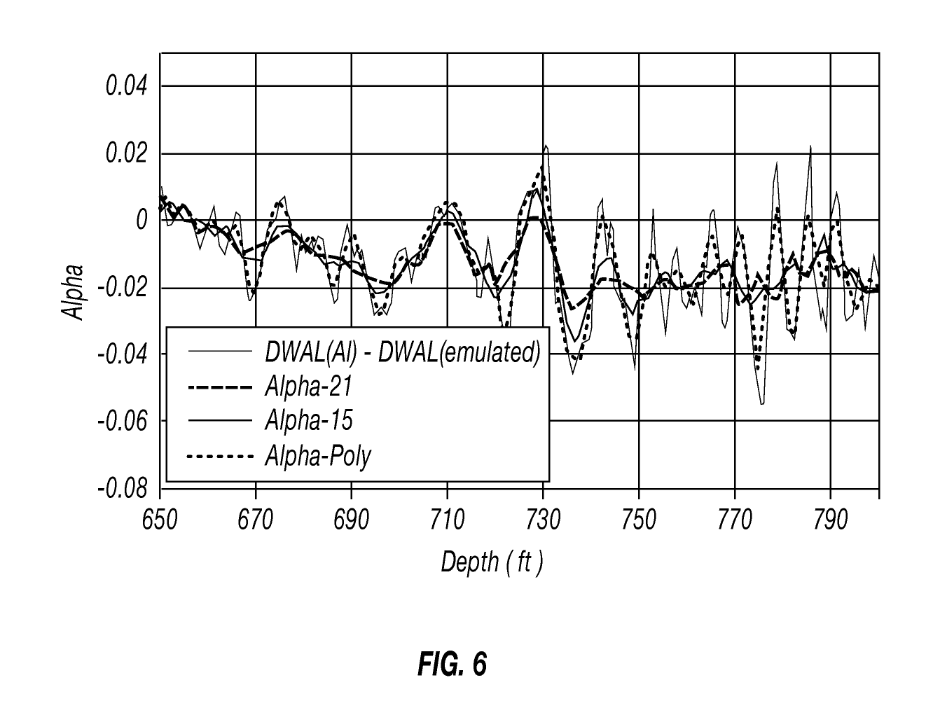

FIG. 6 shows a graph of difference between “precise” and “accurate” and alpha-factors derived from the difference, alpha-15 corresponds to a 15-level average, alpha-21 to a 21-level average and alpha-poly to a curve approximation by a 3^{rd} order polynomial over 15-levels, where the midpoint of the polynomial is used instead of the 15-level average

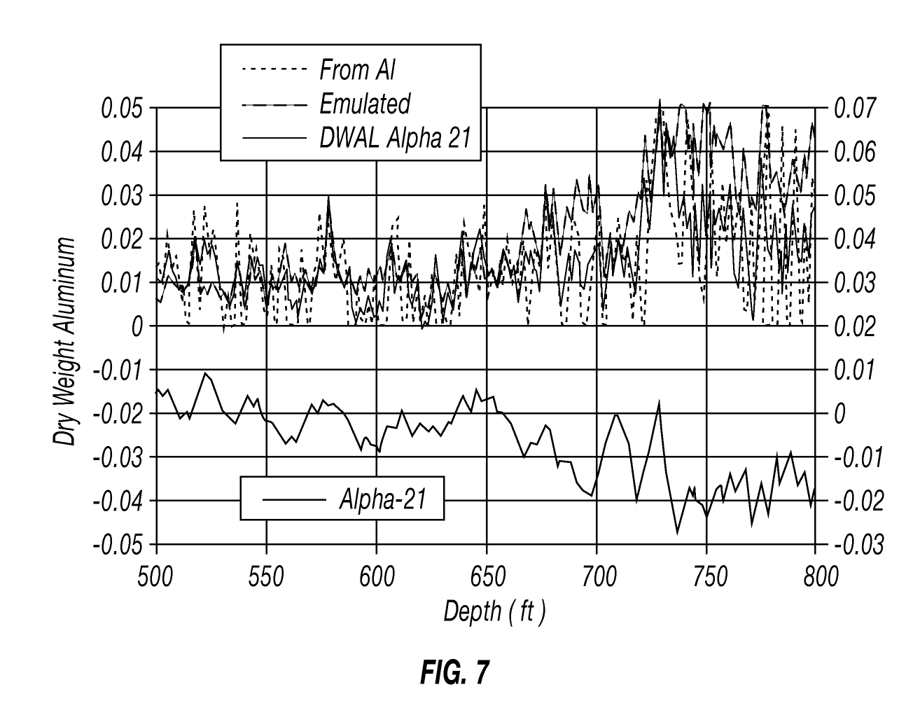

FIG. 7 illustrates the present example processing approach in its simplest embodiment as it could be applied to the aluminum dry weight. The figure shows the accurate (Al) and indirect (Emulated) measurements and the accurate and precise result (DWAL_Alpha_{—}21) obtained using an alpha value obtained from the average difference over 21 levels. The value of the difference α₀ is shown in the solid curve below. The differences between accurate and precise measurements may be averaged over a certain number of depth levels. The resulting average is the 0-th order alpha value α₀.

$${α}_{0} = \frac{1}{2 n + 1} {\sum }_{i = - n}^{i = n} ( {accurate}_{i} - {precise}_{i} ) and \\ alpha\_processed = precise + {α}_{0} \qquad ( 7 )$$

It is possible that instead of a simple sliding average of the difference between the two curves one could use a more sophisticated approach, such as a higher order polynomial fit over a large number of depth levels. In this case, the sliding average may be replaced by approaching the behavior of the difference between the precise and the accurate value by defining the value of alpha at each point as the midpoint of a higher order polynomial or another function fit over the selected depth interval. The use of a higher order polynomial to determine the difference Alpha at every depth level (or time) helps to reduce or prevent artifacts in the alpha-processed results if there are sharp changes in the value of alpha. This is evident in the graph of FIG. 7 in places where there are sharp transitions in the difference, which are much better followed by the polynomial approach than the simple average. More complex filtering schemes may be applied to the difference such as triangular or exponential filters.

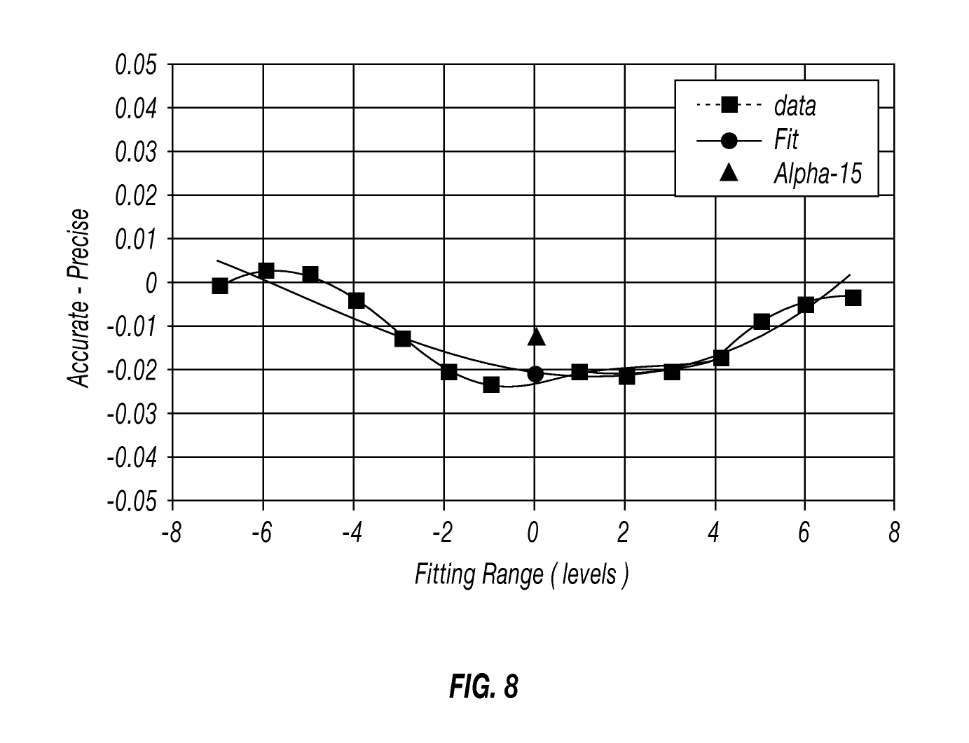

FIG. 8 shows an example of the result of the fit of a third order polynomial to a set of 15 consecutive data output points spaced 6 inches apart. The center point of the fit and the value obtained by determining the average difference (alpha-0) over this distance show clearly that the polynomial follows the difference more accurately.

The result of applying alpha processing to the precise and accurate outputs shown in FIG. 4 is shown in the graph in FIG. 7. In this case, Alpha_{—}0 was added to the precise results to obtain the alpha-processed value. If the errors of the precise and the accurate measurements are independent, then the error on alpha_{—}0 can be calculated by the expression:

$${σ}_{{α}_{0}} = \sqrt{\frac{{σ}_{accurate}^{2} + {σ}_{precise}^{2}}{2 n + 1}} \qquad ( 8 )$$

and the precision of the alpha processed result σDWAL(α) may be determined by the expression

$${σ}_{{DWAI}_{α}} = \sqrt{\frac{{σ}_{accurate}^{2} ( 2 n + 2 )}{2 n + 1} + \frac{{σ}_{precise}^{2}}{2 n + 1}} \qquad ( 9 )$$

It is possible that the difference between the accurate and precise measurements is not constant but may be a function of the precise measurement and that a more complex functional form needs to be used. As a different implementation to a constant offset, one may use the ratio between the averaged precise and accurate values, or, combining the two, use a linear function of the form shown in equation (10):

V_{Al}(α)=α₁·V_{Al}_{_{—}}_{emulated}+α₀ (10)

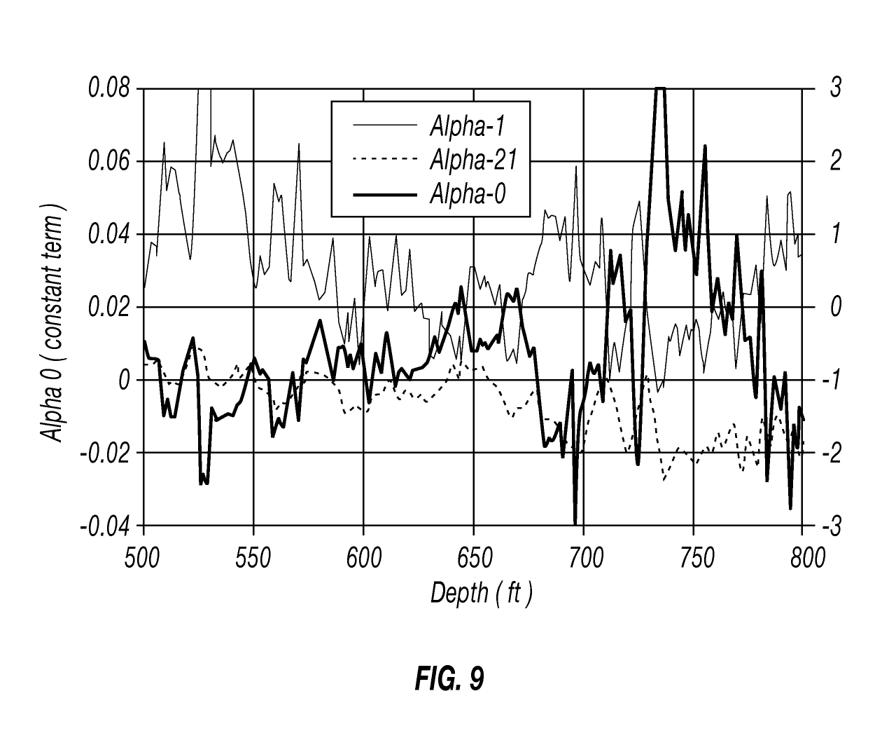

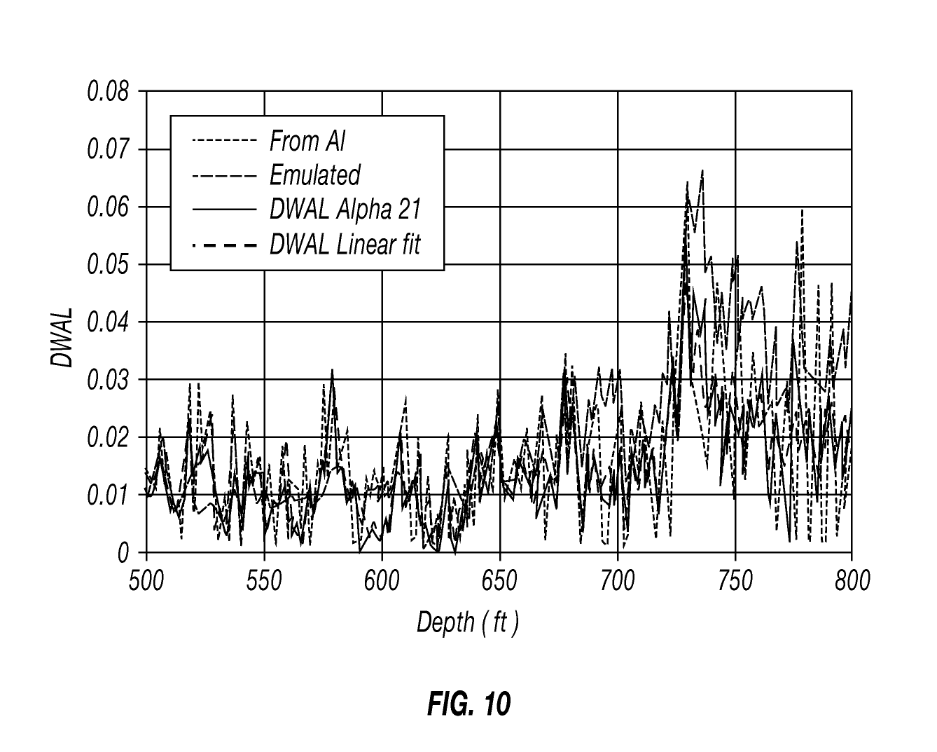

The values of a₀ and a₁ are obtained by a fit to the data points over a long interval. The example in FIG. 9 shows the following: Alpha-21 representing the approach using just the average difference over 21 levels, Alpha-0 and Alpha-1 corresponding to the constant term in equation (10) and to the first order (linear) term of the same equation obtained over a 25-level interval. The dry weight results of applying this approach are shown in FIG. 10. The “linear” approach appears to give a less statistical answer, while generally following the accurate curve. However, the large variability in the correlation (large covariance between alpha_{—}0 and alpha_{—}1) may make the results questionable. Additional constraints on the fit limiting the variability from one level to the next may be applied to obtain more stable results.

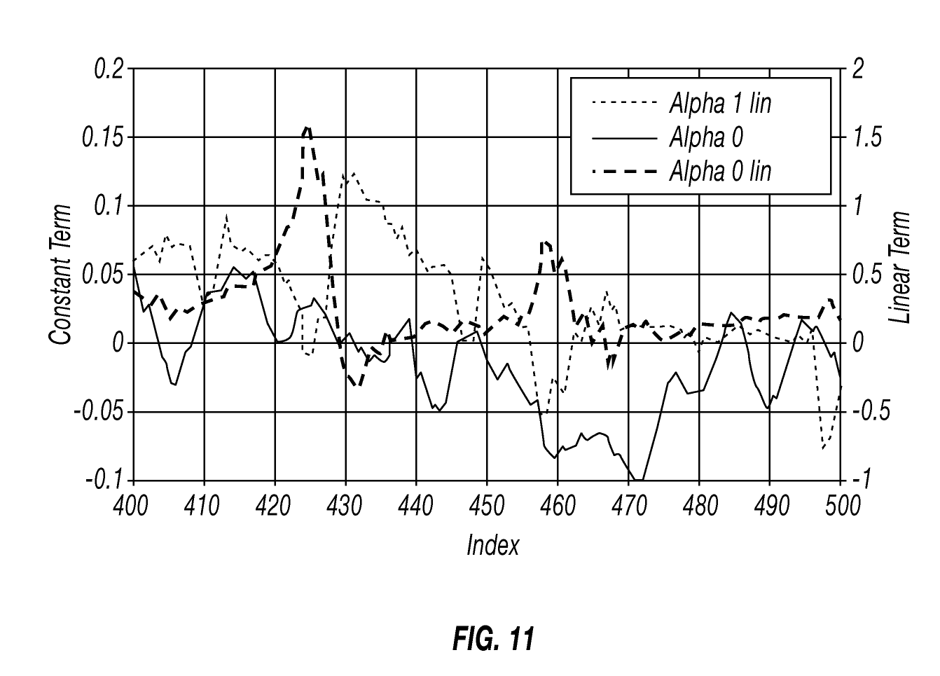

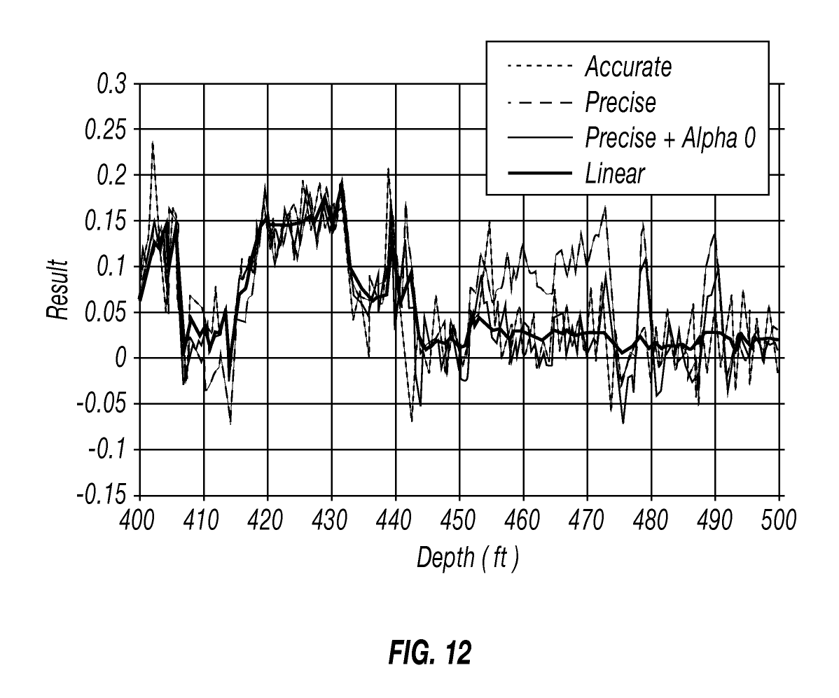

FIG. 11 shows an example of processing results from a different log. In this example a volume of oil was determined from a direct and an indirect measurement of carbon and oxygen using gamma spectroscopy. For simplicity, the curves are only labeled accurate and precise. In this case, the covariance between alpha-0 and alpha-1 appears much smaller, i.e. the two parameters appear largely independent of each other. The resulting alpha processed curve (see FIG. 12) shows very little variability but may be missing some features. This can be addressed by changing the fitting length either by using a shorter length throughout or by adapting the fitting length to the variability of the changes between the accurate and precise curve.

The alpha processing described herein is not limited to determining aluminum and/or clay dry weights and/or volumes. The described processing may also be used to take advantage of elemental yields determined from different neutron interactions with the subsurface formations. Examples may include magnesium or aluminum, where the inelastic neutron collision gamma ray yield may be more precise than the thermal neutron capture yield. In particular, the precision of the thermal neutron capture signal may be impacted in the presence of high salinity in the borehole or formation, where the capture gamma ray signal resulting from chlorine nuclei may contribute more than 70% of the total capture spectrum. On the other hand the capture yield may provide a more accurate dry weight answer.

While the example method has been described in terms of using a symmetric interval around the measured depth of interest (data output level) the only condition for the correction is that the output level to be corrected be positioned within the depth interval over which the correction function is applied. The location of the output level with respect to the ends of the depth interval may be fixed or it may be adaptable. For example, the point could be moved to the limit of the interval, if data beyond the interval are to be excluded.

Another application would be the use of the processing to combine answers from different measurements of the same quantity by combining the potassium answer from capture and natural gamma ray spectroscopy, combining lithology answers obtained using different approaches such as neutron density cross plots and capture/inelastic spectroscopy, combining Sigma measurements (formation and/or borehole macroscopic thermal neutron capture cross section) from multiple detectors, where a far spaced detector may provide a more accurate but very statistical answer and another detector a more precise answer.

In yet another approach, the dependence between the accurate and the precise measurement may depend on external variables pᵢ as indicated in equation (11):

alpha_processedⱼ=ƒⱼ(precise(1 . . . n),p₁, p₂, . . . , pₙ))) (11)

Such an external parameter could be Sigma (macroscopic thermal neutron capture of the formation (or the borehole)), the formation porosity and the formation density to name a few.

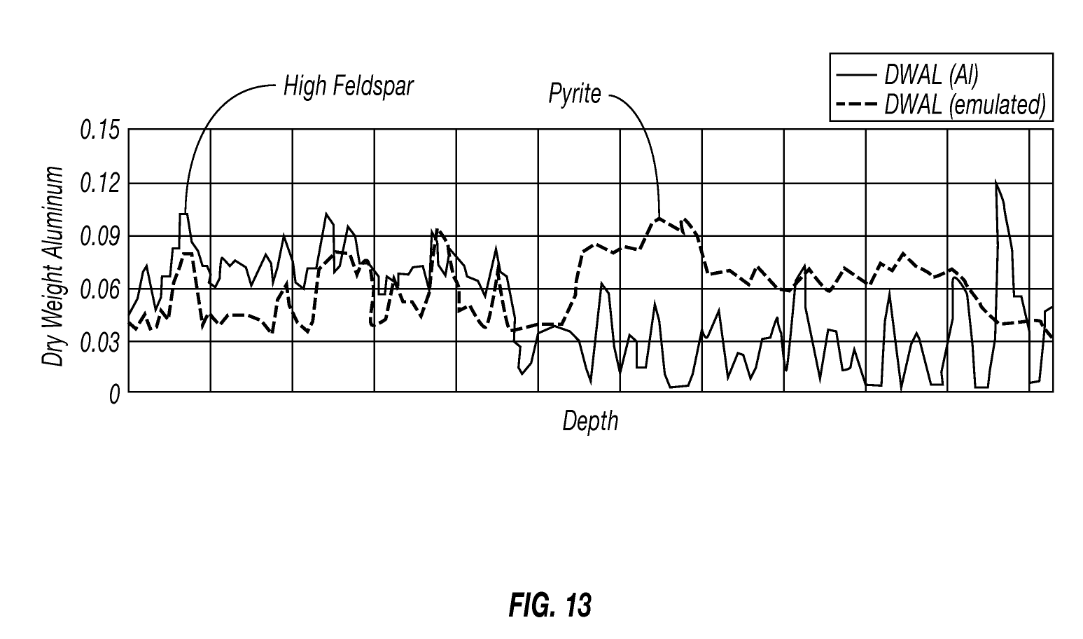

The value of alpha when comparing an emulated and a direct measurement can be used to infer additional information about formation characteristics because deviation of the emulated measurement from the direct measurement may be indicative of the fact that the emulation model is not accurately describing the formation characteristics. As indicated in FIG. 13, aluminum yield determined from a direct measurement may be expected to be higher than aluminum yield determined indirectly in arkosic environments where an abnormally large fraction of the aluminum is contained in minerals known as feldspars. The same relationship may also be expected in environments where the dominant clay type is kaolinite. Directly determined aluminum yield may be expected to be lower than emulated aluminum yield when there is a source of iron not associated with clay, such as from siderite or pyrite (see FIG. 13), or when the iron content of the clay is abnormally high, such as if the clay is predominantly iron-rich chlorite. Therefore it may be possible to use the value of alpha to indicate the presence of one or more of the foregoing minerals.

Another possible reason for directly determined aluminum yield to be lower than emulated aluminum yield would be the existence of an uncorrected iron weighting agent in the drilling fluid, especially if this condition exists throughout the entire well. Upon detecting such a condition it may be possible to apply a correction for the iron background from the drilling fluid, subject to the condition that the directly determined aluminum yield agrees on average with the emulated aluminum yield throughout the wellbore The accuracy of the wellbore iron correction assumes that none of the other unique environments mentioned above exist over any substantial fraction of the measured axial interval of the wellbore.

A further enhancement to the statistical uncertainty of extracted elemental concentrations or yields can be made using a technique known as redistribution, which has been described in, J. A. Grau and J. S. Schweitzer, Elemental Concentrations from Thermal Neutron Capture Gamma-ray Spectra in Geological Formations, Nucl. Geophys. Vol. 3, No. 1, pp 1-9, 1989. According to the technique described therein, if an elemental yield determined using weighted-least-squares (WLS) spectral analysis is modified based upon more accurate information, e.g., a laboratory analysis or other petrophysical measurement of the formations, the effect of this modification on the yields of all the other elements included in the analysis is predictable from the WLS variance-covariance matrix, and accordingly modifying these other yields should enhance their accuracy and precision also. The described technique redistributes the change in the elemental yield that was modified (j) to the other yields (i) based on a simple equation:

NewYieldi=OldYieldi+Ri.j*(OldYieldj−NewYieldj) (12)

The redistribution coefficients Ri,j=−Vi,j/Vj,j may be calculated from the WLS variance covariance matrix V. Some of Ri,j will be positive, some negative; summing Ri.j over all elemental yields will always equal unity. In the present example the enhancement comes from redistributing the difference between the original aluminum yield and the aluminum yield needed to match the alpha-filtered aluminum dry weight. Since the alpha filtering described here works in weight-fraction space rather than spectral yield space the redistribution equation may be rewritten as:

NewWeighti=OldWeighti+Ri.j*(OldWeightj−NewWeightj)*Sj/Si (13)

where Si is the weight-fraction sensitivity for element i. Since iron correlates quite strongly with aluminum in the WLS analysis of neutron-induced capture spectra we expect this enhancement to have a notable influence on the iron yield. A typical redistribution coefficient for aluminum to iron is 0.45.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for improving precision of an accurate measurement of material composition of formations determined by gamma ray spectral analysis, comprising:
in a computer, determining an accurate value of an amount of a selected material in the formations by analyzing a spectrum of gamma rays detected from the formations at a selected axial position along a wellbore using a technique that directly relates the gamma ray spectrum to the amount of the material;
in the computer, determining a precise value of the amount of the selected material by analyzing the spectrum of detected gamma rays using a technique that indirectly relates the gamma ray spectrum to the amount of the material;
in the computer, determining a function relating the accurate value to the precise value over a selected axial interval along the wellbore; and
in the computer, applying the function to the precise value at at least one selected axial position along the wellbore to determine an accurate and precise value of the amount of the material.

2. The method of claim 1 wherein the detected gamma rays comprise at least one of naturally emitted gamma rays, neutron activation gamma rays, thermal neutron capture gamma rays and neutron inelastic collision gamma rays.

3. The method of claim 1 wherein the function comprises an average of a difference between the accurate value and each precise value over the selected axial interval.

4. The method of claim 3 wherein the difference is constant.

5. The method of claim 3 wherein the difference is a function of the accurate value and the precise values over the selected axial interval.

6. The method of claim 5 wherein the difference function is linear.

7. The method of claim 1 wherein the function comprises a polynomial expression relating the accurate value to the precise values over the selected axial interval.

8. The method of claim 1 wherein the material comprises aluminum.

9. The method of claim 8 wherein the indirectly related gamma rays comprise gamma rays emanating from calcium, silicon and iron.

10. The method of claim 1 wherein the at least one selected axial position is at a midpoint of the axial interval.

11. The method of claim 1 further comprising determining in the computer at least one formation characteristic from a value of the function.

12. The method of claim 1 further wherein the function relating the accurate and precise values depends on at least one other petrophysical measurement.

13. The method of claim 1 wherein the difference between the original accurate value and the value obtained through alpha processing is redistributed to obtain a more precise value for the other elements.

14. A method for well logging to determine material composition of formations, comprising:
moving a well logging instrument along an interior of a wellbore, the instrument including at least one gamma ray detector coupled to a spectral analyzer;
in a computer, determining an accurate value of an amount of a selected material in the formations by analyzing the detected gamma ray spectrum at a selected axial position along a wellbore using a technique that directly relates the gamma ray spectrum to the amount of the material;
in the computer determining a precise value of the amount of the selected material by analyzing the detected gamma ray spectrum using a technique that indirectly relates the gamma ray spectrum to the amount of the material;
in the computer, determining a function relating the accurate value to the precise value over a selected axial interval along the wellbore; and
in the computer, applying the function to the precise value at at least one selected axial position along the wellbore to determine an accurate and precise value of the amount of the material.

15. The method of claim 14 further comprising imparting at least one of gamma rays and neutrons to the formations, wherein the detected gamma rays result from interaction of the imparted gamma rays and/or neutrons with the formations.

16. The method of claim 14 wherein the detected gamma rays comprise at least one of naturally emitted gamma rays, neutron activation gamma rays, thermal neutron capture gamma rays and neutron inelastic collision gamma rays.

17. The method of claim 14 wherein the function comprises an average of a difference between the accurate value and each precise value over the selected axial interval.

18. (canceled)

19. The method of claim 17 wherein the difference is a function of the accurate value and the precise values over the selected axial interval.

20. (canceled)

21. The method of claim 14 wherein the function comprises a polynomial expression relating the accurate value to the precise values over the selected axial interval.

22. (canceled)

23. (canceled)

24. The method of claim 14 wherein the at least one selected axial position is at a midpoint of the axial interval.

25. (canceled)

26. (canceled)

27. (canceled)
